(19) United States
(12) Patent Application Publication
(10) Pub. No.: US 2011/0308933 A1
(43) Pub. Date: Dec. 22, 2011

(54) METHOD FOR REMOVING PRECIPITATES IN A BIOFUEL

(75) Inventors: Michael D. Kass, Oak Ridge, TN (US); Samuel A. Lewis, SR., Andersonville, TN (US); Raynella Magdalene Connatser, Knoxville, TN (US)

(73) Assignee: UT-Battelle, LLC, Oak Ridge, TN (US)

(21) Appl. No.: 12/820,177

(22) Filed: Jun. 22, 2010

(51) Int. Cl. B01J 19/10

(52) U.S. Cl. 204/157.62

(57) ABSTRACT

The invention provides a method to remove and/or prevent formation of precipitates in biofuel. The methods comprise subjecting the biofuel to ultrasonic energy.

### STATEMENT REGARDING FEDERALLY SPONSORED RESEARCH

The United States Government has rights in this invention pursuant to contract no. DE-AC05-00OR22725 between the United States Department of Energy and UT-Battelle, LLC.

### FIELD OF THE INVENTION

This invention relates to the field of biofuels, such as biodiesel. In particular, the invention relates to the discovery that ultrasonic energy removes and/or prevents precipitates in biofuels.

### BACKGROUND OF THE INVENTION

Recently there has been renewed interest in expanding the role of biodiesel in the energy plan for the United States. With the rising cost of petroleum and the recognized need to utilize domestic fuel resources to improve the nation's energy security, biofuels, such as biodiesel, offer a promising alternative to help meet the country's energy needs (especially for transportation). Additional concerns about global warming have also led to calls for more renewable energy sources, including alternative fuels.

Biofuels are a wide range of fuels which are derived from biomass, a renewable energy source. Biomass is bioloigcal material derived from a living, or recently living organisms, such as wood, waste, and alcohol fuels. An example of a biofuel is biodiesel.

Biodiesel is made from renewable resources such as soybean oil, other plant oils and animal fat. It can be used in diesel engines and burners (to heat homes) with few or no modifications and can be used either neat (B100), or blended with petroleum diesel (commonly as 20% biodiesel, B20).

Biodiesel has excellent compression ignition fuel properties and has lower particulate matter emissions. However, there is handling issues associated with biodiesel at cold temperatures. At temperatures below the cloud point (e.g., the cloud point for biodiesel is approximately 1° C.), biodiesel begins to solidify and flow properties quickly degrade. Biodiesel also plugs filter systems when it has been exposed to temperatures just above the cloud point. The cause of the plugging is the formation of precipitates which are stable at ambient temperatures (20 to 40° C. or 68 to 104° F.).

The precipitates often cannot be detected by visual inspection. Lack of visual detection indicates that precipitates are on the order of several molecular lengths in size. Several studies suggest that these precipitates are solidified saturated monoglycerides. However, another study suggests that these precipitants are likely formed during the interaction of several constituents, including steryl glucosides. Studies have shown that levels of precipitates are higher in blends of biodiesel and diesel fuel than with biodiesel alone.

### SUMMARY OF THE INVENTION

In one aspect, the invention provides a method to remove precipitates in biofuel. The method comprises subjecting the biofuel to ultrasonic energy.

In another embodiment, the invention provides a method to prevent formation of precipitates in biofuel. The method comprises subjecting the biofuel to ultrasonic energy.

### BRIEF DESCRIPTION OF THE FIGURES

FIG. 1. The effect of sonication on filtration time.

FIG. 2. Filtration time results for biodiesel for each condition tested.

FIG. 3. Gas chromatography-mass spectrometry results for untreated and sonicated biodiesel.

### DETAILED DESCRIPTION OF THE INVENTION

The invention is based on the surprising discovery by the inventors that ultrasonic energy removes and/or prevents formation of precipitates in biofuels. The term “biofuels” as used herein generally refers to a class of fuels derived from biomass (e.g., biological sources, including plant and animal sources). The term “biomass” as used herein generally refers to any bioloigcal material derived from a living, or recently living organisms, such as wood, waste, and alcohol fuels. Thus, biofuels useful in accordance with the methods of the present invention include plant and animal based biofuels.

Alcohol fuels useful as biofuels in accordance with the method of the present invention include alkanols, having an alkane substituted with a hydroxyl group, such as methanol (CH₃OH), propanol (C₃H₇OH), ethanol (C₂H₅OH), butanol (C₄H₉OH), and the like. Alcohols, such as ethanol, also known as ethyl alcohol or grain alcohol, can be produced from virtually any type of plant matter. In particular, grains like corn, barley, sorghum, and wheat, which contain high starch levels, can be broken down into sugars needed for traditional fermentation and conversion to ethanol or other alcohols, which is then used as a fuel. Other non-limiting examples of sources of alcohols for biofuels are cellulose-based and/or lignocellulose-based plant matter, such as switch grass, corn stalks, wheat stalks, agricultural, municipal, paper industry, and forestry waste products.

In one embodiment, the biofuel useful in accordance with the methods of the present invention is biodiesel. Biodiesel is the name given to a variety of ester-based oxygenated fuels made from vegetable oils, fats, greases and other sources of triglycerides such as animal fats. Biodiesel is a clean-burning diesel replacement fuel that can be used in compression ignition (CI) engines and is manufactured from renewable non-petroleum-based sources, including but not limited to, organic fats and oils such as virgin vegetable oil, recycled oil, such as used fryer oil and grease trap materials, and animal fats, such as lard and beef tallow. Non-limiting examples of these ester-based oxygenated fuels include soybean oil, peanut oil, coconut oil, palm oil, canola or rapeseed oil, algae oil, jatropha oil, animal fat tallow, waste vegetable grease, and other similar sources.

In another embodiment, the biofuel useful in accordance with the methods of the present invention is vegetable oil fuel. The vegetable oil fuel can be waste vegetable oil, straight vegetable oil, pure plant oil, and combinations thereof. Waste vegetable oil generally refers to vegetable oil that has been used. For example, waste vegetable oil may be used oil discarded from a restaurant. Examples of vegetable oils, include, but are not limited to, soybean oil, peanut oil, coconut oil, palm oil, canola oil, rapeseed oil, olive oil, etc.

In another embodiment, the biofuel used in accordance with the methods of the invention can be a biofuel blend. As used herein, the biofuel blend can be a mixture of at least any one of the biofuels described above with another fuel type. For example, the biofuel blend can be a mixture of biodiesel and diesel. Another example of a biofuel blend is a mixture of biodiesel and gasoline.

In order to remove and/or prevent formation of precipitates in biofuels, the biofuel is subjected to ultrasonic energy. As used herein, the term “precipitates” refers to agglomerates that form when biofuel approaches temperatures near its cloud point. Without wishing to be bound by theory, it is believed that the precipitates are composed of sterols, present as micro-constituents in the biofuel, which aggregate into complexes with monoglycerides and diglycerides. It is believed that the monoglycerides and diglycerides are the result of incomplete trans-esterification of the biofuel feedstock. The precipitates can be for example, about 200 to 300 microns in diameter.

The terms “ultrasonic energy” or “sonication” generally refers to the act of applying ultrasound energy to a material. In accordance with the methods of the invention, the material is biofuel. The method of applying the ultrasonic energy to the biofuel is not critical, forms no part of the present invention, and may be performed in any manner so long as precipitates are removed and/or formation prevented in the biofuel. The biofuel can be subjected to ultrasonic energy by any method known to those skilled in the art for applying ultrasonic energy to a material. For instance, the biofuel can be subjected to ultrasonic energy by such methods including, for instance, an ultrasonic bath, an ultrasonic probe, a flow through ultrasonic apparatus, etc.

The ultrasonic energy is typically applied to the biofuel at an energy sufficient to remove and/or prevent formation of precipitates in the biofuel. For instance, the minimum energy is generally at least about 2000 Joules, more typically at least about 3000 Joules, even more typically at least about 4000 Joules, and still even more typically at least about 5000 Joules. The maximum energy is generally at most about 10,000 Joules, more typically at most about 9000 Joules, and even more typically at least about 8000 Joules, and still even more typically at most about 7000 Joules.

High intensity ultrasound can generate significant levels of thermal energy. Accordingly, the ultrasonic energy is generally pulsed to prevent excessive heating of the biofuel. For example, the biofuel can be pulsed for various time intervals depending on such factors including, but not limited to, the amount of energy utilized, the volume of biofuel being treated, etc. Those skilled in the art can readily determine the appropriate conditions in order to prevent excessive heating of the biofuel, such that precipitates are removed and/or their formation prevented in the biofuel. For example, the biofuel can be pulsed for an interval of forty seconds on, thirty seconds off, thirty seconds on again, etc.

In one aspect, the ultrasonic energy removes precipitates in biofuels. As used herein, the phrase “remove precipitates” generally means that the precipitates that can clog a filter are generally dissociated. Precipitates that can generally clog a filter are typically at least about 50 microns in diameter, at least about 60 microns in diameter, even more typically at least about 75 microns in diameter, and even more typically at least about 100 microns in diameter. For example, the biofuel precipitates can have a diameter from about 200 to about 300 in diameter. In one embodiment, at least about 50% of the precipitates are removed from the biofuel, more generally at least about 60% of the precipitates are removed, even more generally at least about 70% of the precipitates are removed, and even more generally at least about 90% of the precipitates are removed from the biofuel.

In another aspect, the ultrasonic energy prevents precipitate formation in biofuels. As used herein the phrase “prevent formation” generally means that precipitates that are capable of clogging a filter are generally not formed when the biofuel is subjected to a temperature close to its cloud point. For example, the cloud point of biodiesel is approximately 1° C. Accordingly, as used herein, the phrase “a temperature close to its cloud point” refers to a temperature that is at most 5° C. above the biofuel's cloud point, more generally at most 4° C. above the biofuel's cloud point, and even more generally at most 3° C. above the biofuel's cloud point. As discussed above, precipitates that can generally clog a filter are typically at least about 50 microns in diameter, at least about 60 microns in diameter, even more typically at least about 75 microns in diameter, and even more typically at least about 100 microns in diameter. In one embodiment, preferably no precipitates are formed compared to a control biofuel sample (i.e., unsonicated biofuel subjected to a temperature below its cloud point), more typically at least 90% of the precipitates are prevented from forming compared to a control biofuel sample, even more typically at least 80% of the precipitates are prevented from forming compared to a control biofuel sample, and even more typically at least 70% of the precipitates are prevented from forming compared to a control biofuel sample.

The ultrasonic energy can be applied to the biofuel in any location. In one embodiment, the ultrasonic energy is applied to biofuel in a storage tank (e.g., fuel storage tank at a refinery, fuel storage tank located at a fuel station pump, storage tank of a tanker truck, etc. In another embodiment, the ultrasonic energy is applied to biofuel in a fuel line (e.g., fuel line of a transportation vessel, such as a car, etc.).

### EXAMPLES

### Example 1

### Materials and Methodology

The biodiesel product used in this study was SoyGold 1000 industrial solvent (manufactured by SoyGold). SoyGold 1000 is a high-grade biodiesel composed of soybean methyl esters. Key properties of SoyGold 1000 are listed below in Table 1.

TABLE 1
Key Properties of SoyGold 1000.

| Property | Value |
|---|---|
| Low volatile organic compounds | 7.29 |
| (VOC), % | |
| Kauri butanol value | 61 |
| Specific gravity, g/mL | 0.882 |
| Boiling point, ° C. | 333 |
| Flashpoint, ° C. | >150 |

Untreated SoyGold B100 biodiesel was sonicated initially to rule out any non-additive related changes in filter times. This step is necessary since SoyGold 1000 contains 0.17 to 0.24 wt. % of monoglyceride (MG) compounds. Therefore, it is important to remove any pre-existing MG precipitates and/or isolate their contribution to the time required to pass the biodiesel through the filter. High intensity ultrasound can generate significant levels of thermal energy. Therefore, the sonifier was pulsed to prevent excessive heating. The temperature rise during sonication was measured using a thermometer and reached a bulk temperature of 66° C. In order to separate the bulk thermal effect from the sonication-induced thermovisous contribution, an unsonified control specimen was heated to 66° C. via a hot plate for comparison.

The combination and levels of components used in this study (20 ppm steryl glucoside (SG), 40 ppm SDS, and 500 ppm water) result in the highest filter time with no added MG. The procedure to add the spiked components to the neat biodiesel was as follows:
1. Steryl glucoside was added at 10% in pyrene to reach 20 ppm weight/volume biodiesel. The resulting SG/pyrene blend was subsequently added to neat biodiesel and the fuel mixture was stirred and heated to 90° C. under vacuum for 30 minutes to remove excess pyrene.
2. 40 ppm sodium dodecylsulfate (SDS) and 500 ppm water were combined and stirred into the SG-spiked biodiesel at 70° C. for 20 minutes in a nitrogen environment. Once the spiked fuel reached room temperature, it was placed in the refrigerator or analyzed for filtration rate, depending on the experiment being done. Unspiked control samples were placed directly into the refrigerator. After 16 hours at 2.8° C. in the refrigerator, the samples were removed and allowed to come to room temperature over two hours, which was checked daily to be 24±1° C.

Acoustic energy was applied to 70 ml biodiesel samples using a Branson 450 watt 20 kHz sonifier. To minimize bulk heating, the sonifier was operated for 40 seconds, turned off for 30 seconds and then operated for another 30 seconds. Using this approach, the maximum temperature reached was 66±2° C. Thermal control tests were performed by heating clean biodiesel to 68° C. (using a hot plate) in atmospheric conditions. The heated sample was removed from hot plate and allowed to cool to room temperature.

To measure the cold soak filtration of the samples, the cold soak filtration apparatus was assembled using the ASTM D 7501 cold soak filtration standard. The ASTM procedure however was modified by reducing the sample fluid size passing though the filter. The reduction in sample volume decreases the filtration time but should not affect the comparison of the performance of the samples. For each sample, three specimens were evaluated to assess variance. The total sample size was 70 mL and filtration times were measured for 50 mL (of the 70 mL) to pass through a Whatman glass fiber filter (GFF, Cat. No. 1825-047).

### Example 2

### Sonic Energy Reduced Filtration Time of Untreated Biodiesel

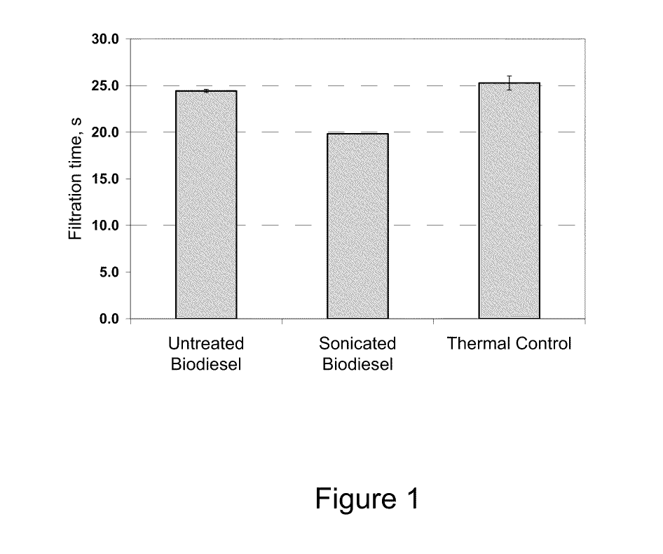

A sample of unspiked biodiesel was sonicated and the filtration result was compared to untreated biodiesel and a thermal control (heated to 66° C.). The results presented in FIG. 1 show that the application of sonic energy reduced the filtration time by 19% from the original condition. This result suggests that some level of precipitates were present in the as-received biodiesel, which is not surprising since all commercial biodiesels contain precipitate precursors.

The data in FIG. 1 also show that the application of heat alone will not improve filtration time. Both the sonicated and the thermal control specimens underwent bulk heating to 66° C., but only sonication effectively reduced filtration time. Therefore, the results indicate that the thermoviscous effects associated with the application of acoustic energy were responsible for the improved filtration times. In fact the slight increase in filtration time associated with the thermal control may be caused by the partial oxidation of the methyl ester compounds. The oxidized fuel molecules are larger than the starting methyl esters, thereby increasing the filtration time considerably in the thermal control sample.

### Example 3

### Sonic Energy Prevents Formation of Precipitates in Biodiesel

Biodiesel samples were subjected to combinations of sonication and refrigeration to assess the influence of the applied sonication and filtration time. The conditions for each biodiesel sample were:
1. Original untreated condition,
2. Sonicated,
3. Sonicated followed by refrigeration,
4. Sonicated followed by spiked,
5. Sonicated followed by spiked followed by refrigeration (approximately 4° C.), and
6. Sonicated followed by spiked followed by refrigeration (approximately 4° C.) followed by sonication.

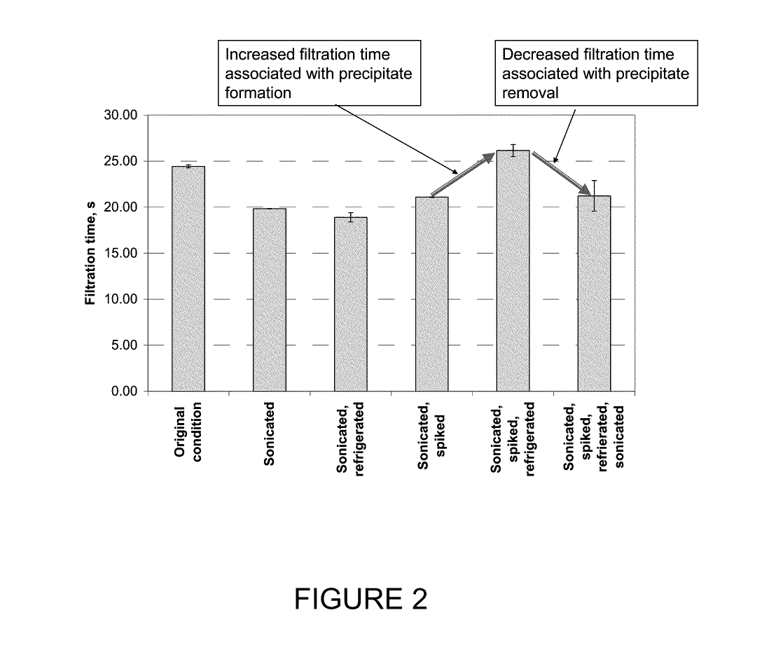

Because sonication was found to improve the filtration time of the untreated biodiesel, this initial step was included on all samples to minimize the effect of any pre-existing precipitates. The original sonicated biodiesel was refrigerated to determine if the filtration time increased to the original setting. Interestingly, refrigeration did not increase filtration time; in fact, refrigerating the samples slightly reduced the filtration time. It appears that sonication may permanently alter the precipitate structure so that the precipitate can no longer form upon cooling. Spiking the sonicated biodiesel causes a moderate increase in filtration time as shown. When the spiked biodiesel is refrigerated, the filtration time increases by 24% (and approaches the original filtration time value) which is consistent with the formation of precipitates. However, the application of sonication to the spiked and refrigerated biodiesel effectively decreases the filtration time to the level approaching the original sonicated value. See FIG. 2.

### Example 4

### Sonic Energy does not Significantly Change Methyl Ester Molecular Chains of Neat Biodiesel

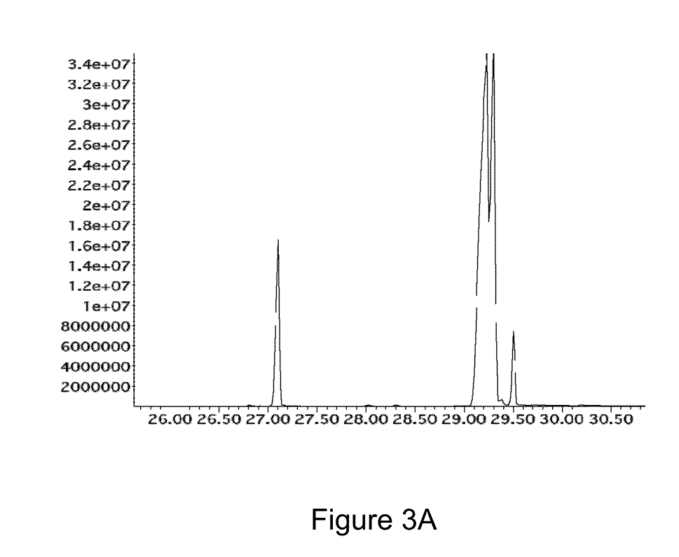

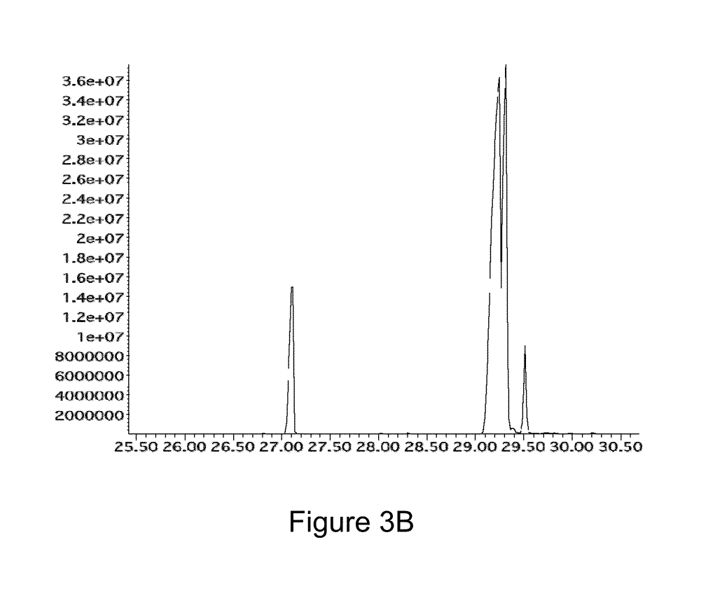

In addition to redissolution of the precipitates as shown in Examples 1 and 2, the effect of sonication may also crack the methyl ester molecular chains into smaller compounds, which, would be able to pass more readily through the filter, thereby lowering filtration time. In order to determine whether significant molecular cracking occurred, a gas chromatography-mass spectrometry (GC-MS) analysis was performed on the untreated and sonciated biodiesel. The GC-MS results are shown in FIG. 3A (untreated) and 3B (sonicated) and the corresponding molecular counts associated with the key methyl ester groups are shown in Table 2. The data indicated that there was no significant structural change of neat biodiesel associated with sonication.

TABLE 2
Molecular Area Ion Counts for Biodiesel Methyl Esters

| Biodiesel Constituent | Untreated | Sonicated |
|---|---|---|
| Hexadecanoic Acid | 7472539 | 7170672 |
| 9,12-Octadecadienoic Acid | 14799084 | 15169731 |
| 9-Octadecenoic Acid | 2163726 | 2381758 |
| Octadecanoic Acid | 3681575 | 3730697 |

What is claimed is:

1. A method to remove precipitates in biofuel, the method comprising subjecting the biofuel to ultrasonic energy.

2. The method according to claim 1, wherein the biofuel is plant based biofuel.

3. The method according to claim 1, wherein the biofuel is an animal-fat based fuel.

4. The method according to claim 2, wherein the biofuel is vegetable oil fuel.

5. The method according to claim 4, wherein the vegetable oil fuel is selected from the group consisting of waste vegetable oil, straight vegetable oil, pure plant oil, and combinations thereof.

6. The method according to claim 1, wherein the biofuel is biodiesel.

7. The method according to claim 6, wherein the biodiesel is plant based biodiesel.

8. The method according to claim 6, wherein the biodiesel is animal-fat based biodiesel.

9. The method according to claim 1, wherein the biofuel is in a storage tank.

10. The method according to claim 1, wherein the biofuel is in a fuel line.

11. The method according to claim 1, wherein the biofuel is a biofuel blend.

12. A method to prevent formation of precipitates in biofuel, the method comprising subjecting the biofuel to ultrasonic energy.

13. The method according to claim 12, wherein the biofuel is plant based biodiesel.

14. The method according to claim 12, wherein the biofuel is an animal-fat based fuel.

15. The method according to claim 13, wherein the biofuel is vegetable oil fuel.

16. The method according to claim 15, wherein the vegetable oil fuel is selected from the group consisting of waste vegetable oil, straight vegetable oil, pure plant oil, and combinations thereof.

17. The method according to claim 12, wherein the biofuel is biodiesel.

18. The method according to claim 17, wherein the biodiesel is plant based biodiesel.

19. The method according to claim 17, wherein the biodiesel is animal-fat based biodiesel.

20. The method according to claim 12, wherein the biofuel is in a storage tank.

21. The method according to claim 12, wherein the biofuel is in a fuel line.

22. The method according to claim 12, wherein the biofuel is a biofuel blend.
